(19) United States
(12) Patent Application Publication
(10) Pub. No.: US 2005/0225740 A1
(43) Pub. Date: Oct. 13, 2005

(54) Light source for photolithography

(76) Inventors: Sushil D. Padlyar, Santa Clara, CA (US); Hsuen Yang, San Jose, CA (US); Everett B. Lee, Los Altos, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/816,019

(22) Filed: Mar. 31, 2004

(51) Int. Cl. G03B 27/54

(52) U.S. Cl. 355/67; 430/5

(57) ABSTRACT

A hybrid light source for photolithography is disclosed. According to an embodiment of the invention, a light source comprises, a head, a first set of poles coupled to the head, the first set of poles are located approximately at an outer edge of the head, and a second set of poles coupled to the head located between the outer edge and a center of the head. According to a further embodiment of the invention, the poles are adjustable to change the characteristics of the light source.

### FIELD OF THE INVENTION

The present invention relates generally to semiconductor processing, and specifically to a light source for photolithography.

### BACKGROUND OF THE INVENTION

Integrated circuits, such as microprocessors, typically comprise a silicon or other substrate having many semiconductor devices formed therein. The devices are formed by modifying specific areas of the substrate by doping, adding layers, etc. Several layers of oxides, metals, etc. are then formed on top of the substrate to provide electrical interconnects between the devices. Patterns may be created for the devices and interconnects using a technique known as photolithography. Photolithography typically involves depositing a layer of photoresist over the item to be patterned, exposing a portion of the photoresist to light through a patterned mask to soften it, and removing the exposed portion of the resist. The exposed material beneath the removed resist can then be removed using a selective etch chosen to remove the exposed material and not the photoresist. After the exposed areas are etched, the remaining photoresist can be removed.

Individual features are becoming increasingly small in order to increase device density, and reduce overall device size. As a result, the optics used to pattern the resist need to be improved to allow for tighter pitches and thus smaller device size. “Pitch” refers to the center-to-center distance of features on a substrate, and is typically expressed in terms of nanometers (nm). Small devices are currently in the 140 nm pitch range. A substrate may include semiconductor devices of several different sizes formed on it. For example, a flash memory chip may include flash memory cells patterned in the 140 nm pitch range, as well as a controller that is patterned in the 240-440 nm pitch range.

To pattern a layer of photoresist, light from a light source is shone first through a mask, and then through a lens, which focuses the incident light upon the photoresist. Ideally, the light will focus directly onto the surface of the resist. However, for a variety of reasons, including incident vibrations, temperature and pressure irregularities, etc., the substrate will move toward and away from the lens, moving the focus away from the surface of the substrate. Defocus refers to the distance from the point of focus to the surface of the substrate. For example, if a light source is focused 150 nm above the surface of the substrate, the defocus is said to be +150 nm. “Depth of Focus” (DOF) is a range of tolerance of defocus through which a semiconductor device can be formed without errors. Typically, if the defocus exceeds the DOF, the semiconductor device will result in a yield failure due to incomplete or otherwise erroneous imaging.

A Mask Enhancement Error Factor (MEEF) refers to the amount which an error present in the mask will be multiplied when the mask is transferred to the resist. The MEEF factor depends primarily on the light source and the resist process. For example, a light source may have an MEEF of three. Using this light source, if a feature on a mask is misplaced by 1 nm, the feature will be misplaced by 3 nm when transferred to the photoresist. Reducing the MEEF of a light source improves the accuracy of the photolithography, thereby increasing yields.

FIG. 1 illustrates a prior art cross-quad light source. The light source 100 includes a head 102 in which several poles 104 are located. The poles 104 are the areas in the light source 100 from which light will be projected. As can be seen here, the poles 104 are located at the edge of the head 102, approximately equidistant from each other. The poles 104 can be tailored optimal performance at specific pitch ranges. For example, the poles 104 can be configured to improve DOF tolerance at 140 nm. The cross-quad light source has a MEEF of between 4 and 5 at 240 nm pitch. Further, the cross-quad light source is subject to feature inversion at defocus. When feature inversion occurs, for example, a line patterned on a mask will become a space on the photoresist.

The cross quad design shown in FIG. 1 allows for only a single pitch range to be optimized. However, in many instances a semiconductor device has individual devices formed in more than one range. When patterning small features on the substrate, two different light sources used in two different passes may be required. For example, the light source pictured in FIG. 1 may be useful to pattern in the 140 nm range, however, a second light source with different characteristics may need to be used to provide acceptable DOF and MEEF characteristics in the 240-440 nm range. As a result, two passes need to be made to pattern multiple pitches present at a certain layer.

### BRIEF DESCRIPTION OF THE DRAWINGS

FIG. 1 illustrates a prior art cross-quad light source.

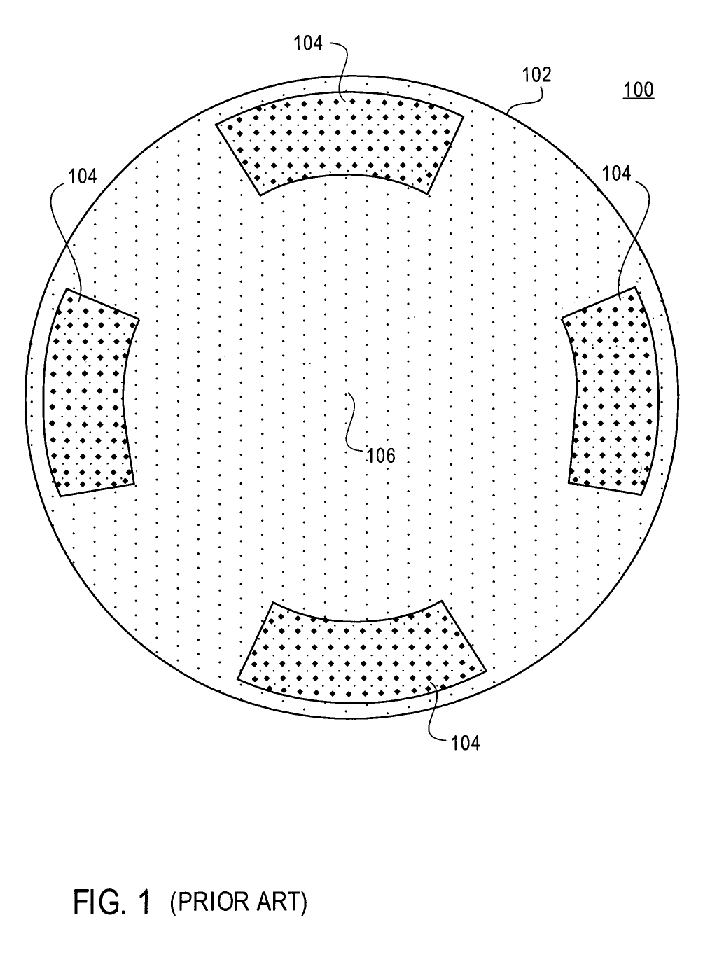

FIG. 2 illustrates an octopole hybrid light source according to an embodiment of the invention.

FIG. 3A is a graph illustrating the tolerable DOF for a hybrid octopole light source and a cross-quad light source.

FIG. 3B illustrates feature inversion when using a cross-quad light source.

FIG. 3C illustrates the lack of feature inversion when using a hybrid light source.

FIG. 4 illustrates a hexapole hybrid light source according to an alternate embodiment of the invention.

FIG. 5 illustrates a process for determining a proper placement of the poles in a hybrid light source.

FIG. 6 illustrates the combination of multiple orders of diffraction using a hybrid light source to improve resolution and contrast during photolithography.

### DETAILED DESCRIPTION

Described herein is a light source for photolithography. In the following description, numerous specific details are set forth. However, it is understood that embodiments may be practiced without these specific details. For example, well-known equivalent materials may be substituted in place of those described herein, and similarly, well-known equivalent techniques may be substituted in place of the particular semiconductor processing techniques disclosed. In other instances, well-known structures and techniques have not been shown in detail in order not to obscure the understanding of this description.

According to a first embodiment of the invention, a light source for photolithography is disclosed. The light source is a hybrid light source having an octopole arrangement, including four poles having an arc shape at an edge of the light source head, and four elliptical or circular poles located closer to the center of the head. The poles of the hybrid light source can be modified to suit different pitch ranges for different devices. This arrangement allows the patterning of two different pitch ranges in a single pass, because the light source may be tailored to improve depth of focus (DOF) tolerances in both pitch ranges. The improved DOF tolerances allow the substrate to move further away from the intended point of focus and still print accurately, thereby resulting in fewer errors. As a result, there are fewer yield losses. The second set of poles toward the center of the head creates more interaction between the zeroth and first orders of diffraction. As a result, greater contrast and resolution is produced, and more accurate imaging over a wider range of DOF is possible. Further, the MEEF of the light source at 240 nm pitch is reduced due to the improved process latitude, and the incidence of feature inversion is reduced.

According to another embodiment of the invention, a hexapole light source is used. The hexapole source includes two arc shaped poles opposite each other at approximately an edge of the light source, and four poles having approximately an elliptical or circular shape located nearer to the center of the light source head. The hexapole design can further reduce the MEEF in the smaller pitch ranges. As with the octopole hybrid light source, the poles may be modified to provide the best characteristics of specific pitch ranges required for a specific semiconductor device.

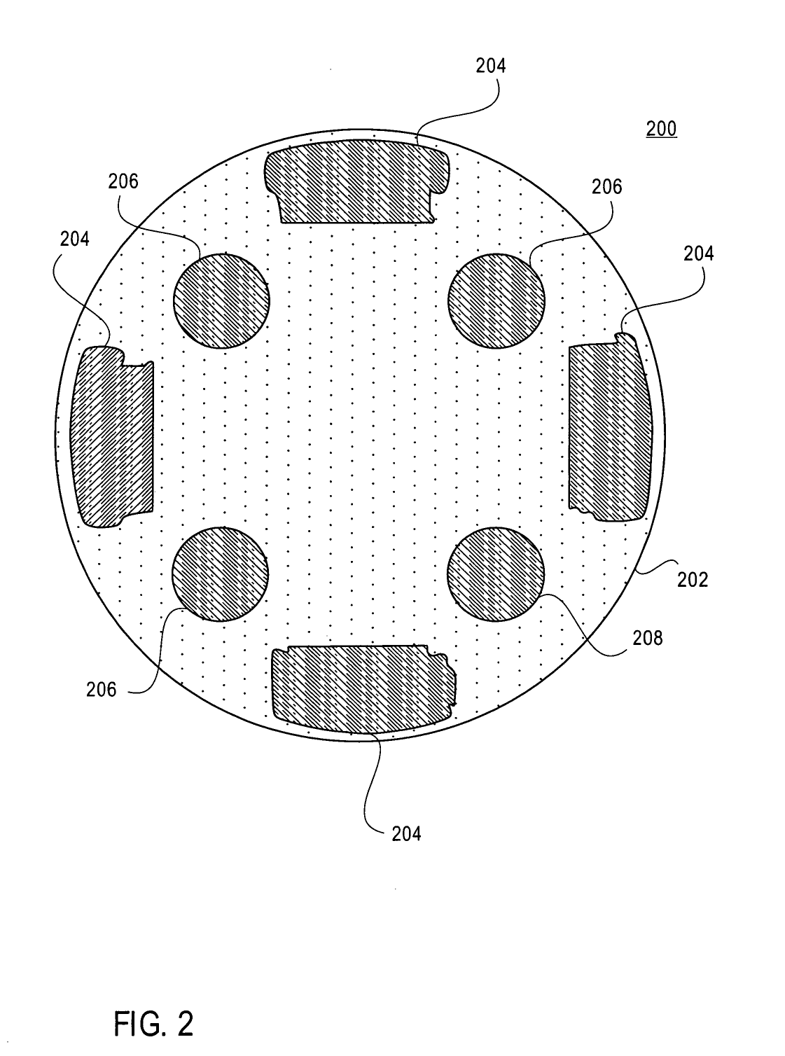

FIG. 2 illustrates an octopole hybrid light source according to an embodiment of the invention. The hybrid light source 200 may be any type of light source appropriate for lithography, such as a gas discharge lamp or excimer laser. The light source can be chosen based on the type of features being printed. Generally, light at smaller wavelengths can print smaller features. For example, a 193 nanometer (nm) excimer laser can print features in the 100-130 nm pitch range.

The hybrid light source 200 includes a light source head 202 including several poles 204 and 206. The light source 200 has an octopole configuration including two sets of four poles each. The octopole configuration of the light source 200 allows a user to configure the light source 200 such that two different pitch ranges can be optimized to have high DOF tolerances. This will result in higher device yields because not only is the imaging more accurate through a wider range of defocus, but since the DOF is high at two pitch ranges, only one pass of the light source is required for devices using two pitch ranges.

A device such as a flash memory chip may have individual features formed in two different pitch ranges. For example, a flash memory chip may have flash memory cells formed in a 140 nm pitch range, while also having a decoder formed in a 240-440 nm pitch range. The outer poles 204 are used to pattern the features in the small pitch range, or the 140 nm pitch range in this example. The inner poles 206 may then be used to optimize DOF tolerances in the large pitch range, or the 240-440 nm pitch range in this example. Previously, either two passes with different light sources were required to optimize DOF tolerances in the two pitch ranges, or one pitch range had low DOF tolerances, thereby leading to greater yield losses.

The outer poles 204 have an arc shape and may be configured such that they improve upon imaging of devices formed in a smaller pitch range. The inner poles 206 are elliptical or circular, and may be adjusted so that they increase DOF tolerances in a larger pitch range. The octopole hybrid light source 200 also exhibits improved mask error enhancement factor (MEEF), which is approximately 2 for the hybrid light source 200 compared with 4-5 for a cross-quad light source. Further, the hybrid light source 200 may be used with an industry standard embedded phase shift mask (EPSM), reducing the cost of implementation since the only changes required are changes to the light source.

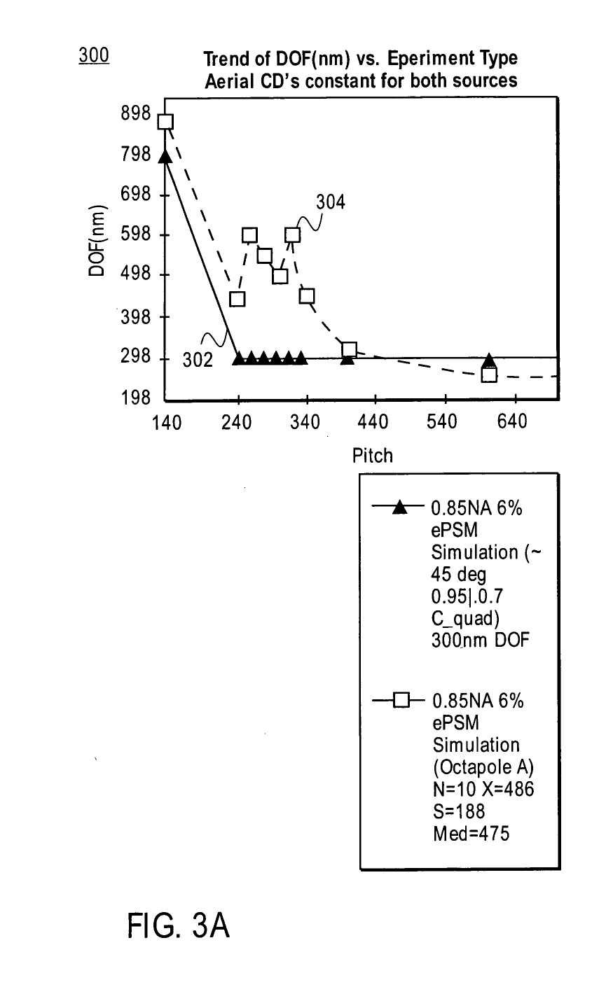

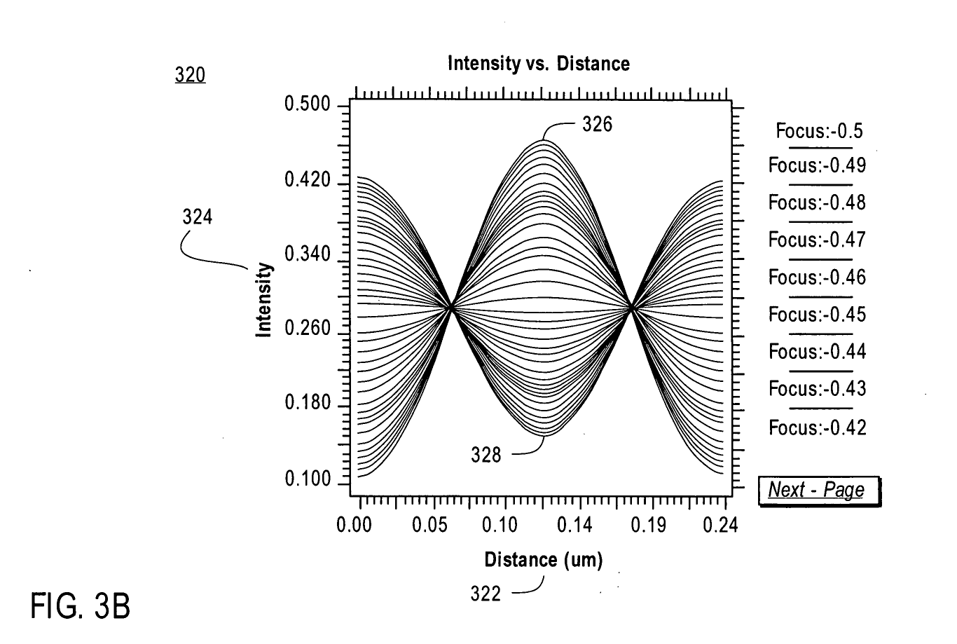

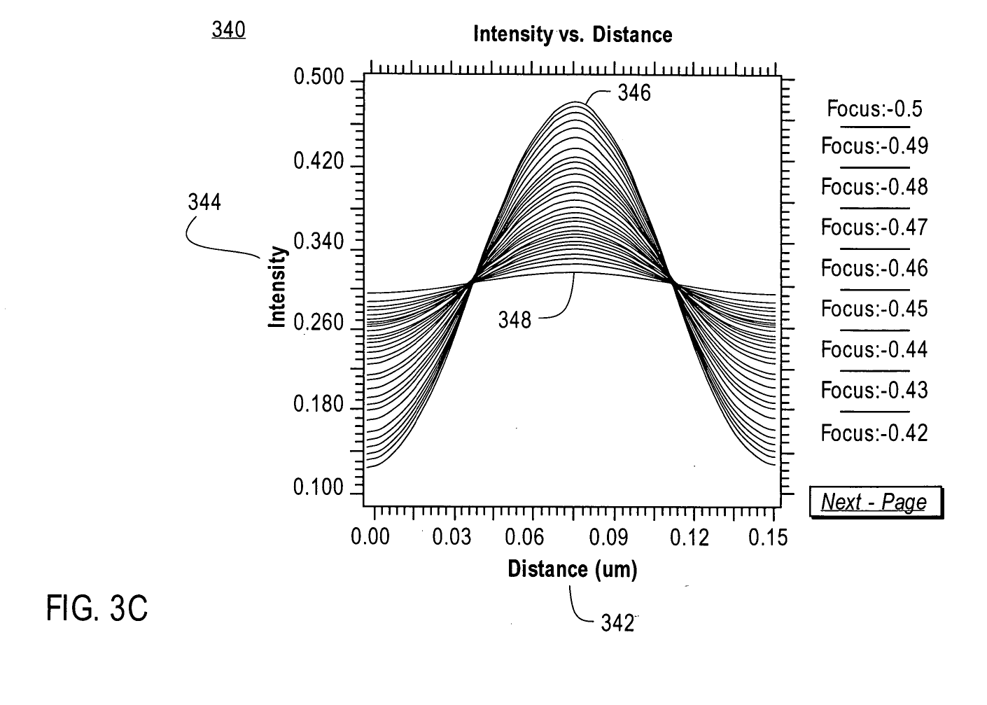

FIGS. 3A-C illustrate characteristics of a hybrid light source compared with the characteristics of a cross-quad light source. These figures demonstrate the superior characteristics of the hybrid light sources compared to light sources currently being used, including better DOF tolerances and a reduction in feature inversion.

FIG. 3A is a graph 300 illustrating the tolerable DOF for a hybrid octopole light source and a cross-quad light source. The line graph 302 illustrates the DOF tolerance for a cross-quad light source at several different pitches. As can be seen, the cross-quad light source has a high DOF tolerance in low pitch ranges, such as the 140 nm pitch range. In contrast, the tolerable DOF for the cross-quad light source is much lower in the larger pitch ranges, including pitches larger than 240 nm. The line graph 304 illustrates the DOF tolerance with a hybrid octopole light source according to an embodiment of the invention. As can be seen, the hybrid light source illustrates a high DOF tolerance at both 140 nm and between 240-440 nm. The second set of poles 206 increases the resolution and the contrast of light projected through a lens. Forbidden zone effects cause the peaks in the line graph 304, and even though these peaks are present, even at its lowest DOF tolerance, the DOF tolerance for the hybrid light source is much greater than for the cross-quad light source. As can be seen, for all pitches below 440 nm, the hybrid light source 200 exhibits superior DOF tolerances.

The hybrid light source 200 may be adjusted to suit different pitch ranges. For example, the hybrid light source 200, as can be seen in FIG. 3A, exhibits a high DOF tolerance at 140 nm and between 240-440 nm. This may be useful when performing lithography for a device that will include features formed in both the 140 nm range and the 240-440 nm range, such as a flash memory device that includes both a controller and a separate array of flash memory cells. However, the poles 204 and 206 may be adjusted to suit other pitch ranges. The poles can be modified, and the changes can then be experimentally verified to determine whether the DOF tolerance in the desired pitch ranges has been improved. Generally, the poles 204 and 206 may be moved closer to the center of the head 202 for improvements in larger pitch regions, and moved toward the edge for improvements in smaller pitch regions. The angle of the poles 204 and 206 in relation to the orientation of the mask may also be adjusted for DOF and MEEF improvements. For example, increasing the radius of the poles increases MEEF and DOF tolerance. Decreasing the radius of the poles reduces the DOF tolerance and the MEEF, but increases the incidence of side-lobes and feature inversion. Depending on the specific application, a user can make modifications to find an appropriate balance between certain characteristics. For example, a user may be willing to tolerate an increase in the MEEF if DOF tolerance is of more importance for a particular application. These modifications can effectively shift the graph 304 to other pitch ranges, as needed.

FIGS. 3B and 3C illustrate how a cross-quad light source may exhibit “feature inversion.” When feature inversion occurs, a feature on the mask is reversed when it is translated to the resist. For example, using a cross-quad light source, in certain pitch ranges, at certain defocus values, a feature that is patterned as a line on the mask will appear as a space on the photoresist, thereby ruining the device. The various hybrid light sources described herein reduce the incidence of feature inversion because they provide an increase in DOF tolerance.

FIG. 3B illustrates feature inversion when using a cross-quad light source. The graph 320 shows several different defocus values. The distance shown on the x-axis 322 of the graph 320 represents the pitch of the feature being patterned, and the y-axis 324 represents the relative intensity of the feature. According to one embodiment, the intensity should be greater than 30% to ensure no feature inversion takes place. The several lines show the intensity at certain pitches when the defocus changes. For example, the top defocus line 326 may represent a defocus value of zero, while the bottom line 328 represents a defocus value that is out of focus. As can be seen, when using the cross-quad source, when the process is out of focus, the intensity drops significantly below 30% and the feature inverts.

FIG. 3C illustrates the lack of feature inversion when using a hybrid light source. Since the DOF tolerance improves, the defocus can be greater, and the light source will still print a non-inverted feature. The axes 342 and 344 are the same as the axes 322 and 324. The top line 346 and the bottom line 348 represent the same relative defocus values as the top and bottom lines 326 and 328. As can be seen, even when the hybrid light source is out of focus (as shown by the bottom line 348), the intensity remains at 30%, and thus no feature inversion takes place.

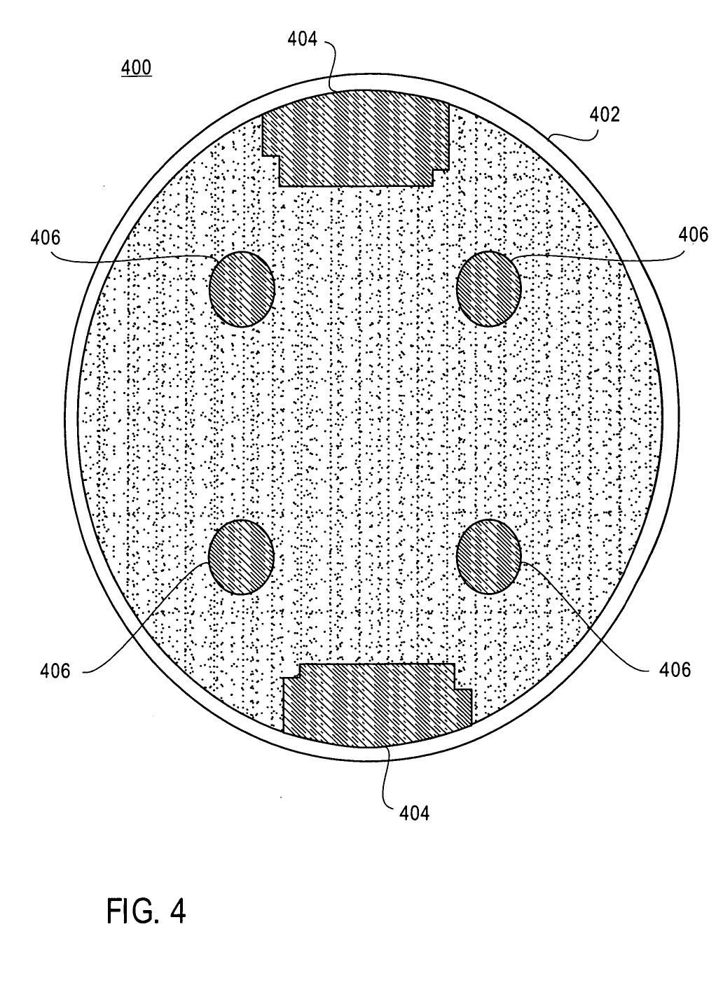

FIG. 4 illustrates a hexapole hybrid light source according to an alternate embodiment of the invention. The hexapole hybrid light source 400 includes a head 402, two outer poles 404 and four inner poles 406. The hexapole hybrid light source 400 may be used where the MEEF of the light source 400 is a concern. By removing two of the outer poles 404, the MEEF is improved compared with the octopole hybrid light source. As mentioned above, reducing the radius or overall size of the poles reduces the overall MEEF. By removing two poles, the overall projection area of the light source 400 is reduced and the MEEF is thereby reduced. This may be helpful in applications where very tight pitches are used or mask irregularities are common, thereby requiring precise imaging. However, as also mentioned above, the reduction in size of the illumination area on the light source 400 may increase the incidence of side lobes and feature inversion.

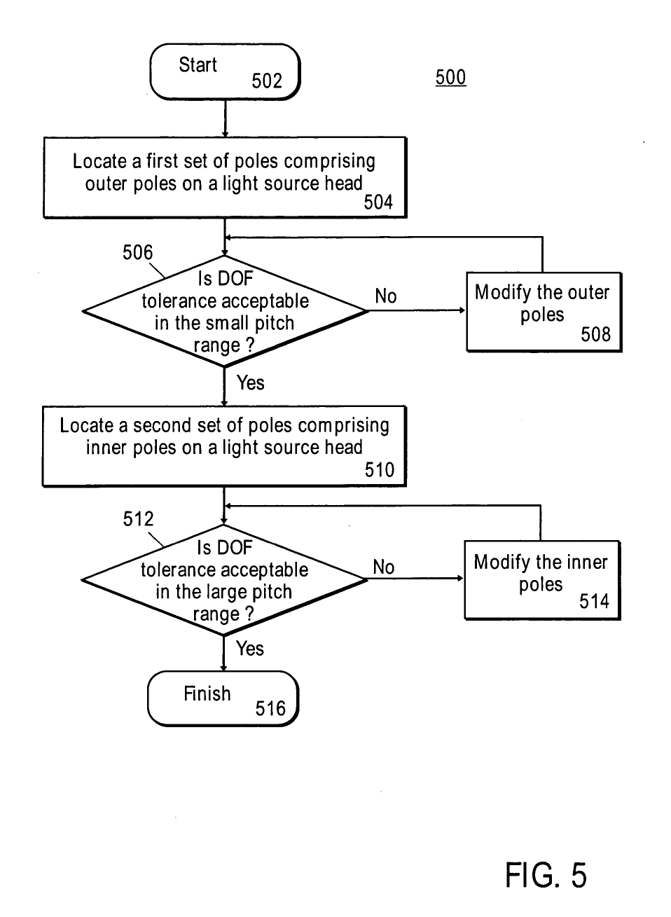

FIG. 5 illustrates a process for determining a proper placement of the poles in a hybrid light source. The configuration of the light sources 200 and 400 illustrated above may be determined using the illustrative process 500. According to one embodiment, the hybrid light source may be designed using a software application that locates the poles as well as determining the resulting characteristics of the light source. Once an appropriate configuration has been determined, a light source can be manufactured.

The process 500 starts in start block 502. In block 504, the first set of poles comprising the outer poles are located on the light source head. The outer poles may comprise two or four poles depending on whether an octopole or hexapole configuration is to be used, as mentioned above. The outer poles are typically used to pattern the tight pitch areas of a semiconductor device. A standard configuration of the poles can initially be used, and the dimensions and location of the outer poles can be modified for a specific application to produce to the required DOF tolerances, as explained below.

In block 506, it is determined whether the DOF tolerance for the chosen configuration of the outer poles is acceptable. Generally, a DOF tolerance of 300 nm is considered marginal, and it is desirable to have a much higher DOF tolerance if possible. However, any tolerance may be used based on the requirements of a specific application. To determine whether the placement of the outer poles results in an acceptable DOF tolerance, an experimental verification is used. A computer simulation may be used to experimentally determine the DOF tolerance for a specific hybrid light source configuration. The DOF tolerance may also be physically verified by printing onto a wafer using the hybrid light source. For example, a substrate may be placed at a distance from an objective lens that is known to be out of focus by a certain amount. If the lithography still results in acceptable tolerances, the placement of the outer poles can be said to be acceptable. Other characteristics of the light source, such as MEEF, etc. may also be experimentally verified at this point.

If the placement of the outer poles is not acceptable, the process 500 continues to block 508, where the size, shape, inclination, and location of the poles may be changed. Generally, the poles are moved closer toward the center of the light source head to increase DOF tolerance in a higher pitch application. Likewise, the poles to be moved inward to increase the tolerance in a lower pitch application. Further, the radius of the poles may be changed to influence DOF tolerance and MEEF, as well as the incidence of feature inversion, etc.

In block 510, a second set of inner poles is placed on the light source head. The second set of poles may be the elliptical or circular poles 206 and 406 shown in the above figures. These poles will typically be used to provide illumination for the larger pitch ranges, such as in the 240-440 nm pitch ranges. The poles may initially be sized and placed according to a standard configuration, and modified based on the resulting characteristics of the light source, as explained below.

In block 512, it is determined whether the resulting DOF tolerance for the second set of poles is acceptable. As mentioned above, the tolerance may be determined using a computer simulation or actually printing a wafer an examining the result. The MEEF and other characteristics of the light source can also be determined. If the configuration of the light source is not acceptable, the process 500 continues to block 514, where the second set of poles is modified. The modifications may include changes to the size, location, etc. of the poles. After the modifications, the process returns to the block 512 where it is again determined whether the tolerance is acceptable for the specific application. If the tolerance is acceptable, the process 500 finishes in block 516.

After completing the process 500, the finished light source can then be used to print a pattern for any semiconductor device, including those having individual features in two pitch ranges, in a single pass. This is the result of increase DOF tolerances in two pitch ranges, as shown in FIG. 3A. Printing in one pass also eliminates the need to connect the two areas after two separate prints are completed. For example, a flash memory chip may include a bank of flash memory cells in one pitch range and a decoder in another pitch range. If two passes are used to print cells and the decoder separately, the cells and the decoder must be physically connected after the printing is completed. Further, the increased DOF reduces the incidence of feature inversion, and overall critical dimension control is improved.

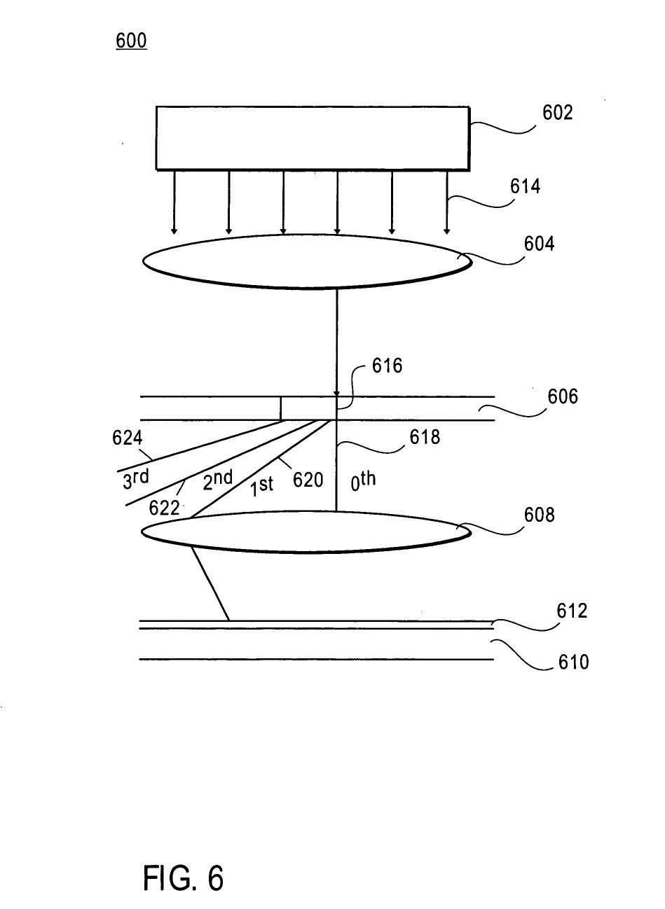

FIG. 6 illustrates the combination of multiple orders of diffraction using a hybrid light source to improve resolution and contrast during photolithography. There are several different types of photolithographic printing, including contact printing, proximity printing, and projection printing. A projection printing process typically involves projecting a light from a light source through projection optics, which may include a first lens, a mask, and a second lens, and onto the photoresist. A projection printing process will be explained below in conjunction with the hybrid light sources described above.

The projection printing system 600 includes a hybrid light source 602, a first lens 604, a mask 606, a second lens 608 and a substrate 610 including a layer of photoresist 612. The hybrid light source 602 may be one of the designs discussed above, and may be a gas discharge lamp, excimer laser, or other known type of light source. The hybrid light source 602 will output several light beams 614 from the various poles through the lens 604 and onto the mask 606. The mask 606 may be a chrome and glass EPSM that is patterned for a specific semiconductor application. The light beams 614 are shone through a small slit 616 in the mask 606. The slit 616 represents an opening that needs to be made in the photoresist 612. The slit 616 as shown is much larger than it would typically be compared to the lenses 604 and 608, and the light source 602, to demonstrate diffraction through the slit 616. When shone through the slit 616 the light beams 614 will disperse on the other side of the mask 606 into several orders of diffraction.

The light beams 614 diffract into a zeroth order of diffraction 618, a first order of diffraction 620, a second order of diffraction 622, a third order of diffraction 624, etc. The diffracted light will then be focused in the lens 608 and onto the photoresist 612. According to an embodiment of the invention, the hybrid light source 602 includes several light poles configured such that the zeroth order 616 on the first order 618 are combined in the lens 606 to improve resolution and contrast. As a result, imaging on the photoresist 610 is more precise, resulting in greater DOF tolerances, lower MEEF, etc. Previously, cross-quad light sources were not able to effectively combine these orders of diffraction, and as a result have lower resolution, lower contrast, and worse DOF tolerances.

This invention has been described with reference to specific exemplary embodiments thereof. It will, however, be evident to persons having the benefit of this disclosure that various modifications changes may be made to these embodiments without departing from the broader spirit and scope of the invention. Specification and drawings are accordingly, to be regarded in an illustrative rather than in a restrictive sense.

1. A light source comprising:
a light source head;
a first set of poles coupled to the head; and
a second set of poles coupled to the head, the second set of poles located between the first set of poles and a center of the head.

2. The light source of claim 1, wherein the first and second set of poles are adjustable to change characteristics of the light source.

3. The light source of claim 1, wherein the second set of poles comprises four poles approximately equidistant from each other.

4. The light source of claim 3, wherein the four poles have an elliptical shape.

5. The light source of claim 1, wherein the first set of poles has an arc shape.

6. The light source of claim 5, wherein the first set of poles comprises four poles.

7. The light source of claim 5, wherein the first set of poles comprises two poles.

8. The light source of claim 1, wherein the light source is an excimer laser.

9. The light source of claim 2, wherein the light source is used for photolithography.

10. The light source of claim 9, wherein the first and second set of poles are adjusted to optimize depth of focus (DOF) tolerances.

11. A method comprising:
locating a first set of poles on a light source;
determining whether a first depth of focus (DOF) tolerance for a first pitch range is acceptable, and if the first DOF tolerance is not acceptable, adjusting the first set of poles;
locating a second set of poles on the light source; and
determining whether a second DOF tolerance for a second pitch range is acceptable, and if the second DOF tolerance is not acceptable, adjusting the second set of poles.

12. The method of claim 11, further comprising determining whether a mask error enhancement factor (MEEF) of the light source is acceptable, and if the MEEF is not acceptable, adjusting the first and second sets of poles.

13. The method of claim 11, wherein determining whether a DOF tolerance is acceptable comprises using a computer simulation.

14. The method of claim 11, further comprising using the light source for photolithography.

15. The method of claim 11, wherein the first set of poles comprises an outer set of arc-shaped poles, and wherein the second set of poles comprises an inner set of elliptical poles.

16. The method of claim 15:
wherein adjusting the first set of poles comprises moving the first set of poles and adjusting a size of the first set of poles; and
wherein adjusting the second set of poles comprises moving the second set of poles and adjusting a radius of the second set of poles.

17. An apparatus comprising:
a hybrid light source including a first set of poles and a second set of poles, the second set of poles is inside the first set of poles;
a mask beneath the hybrid light source, the mask including a pattern; and
a first lens between the light source and the mask, and a second lens between the mask and a substrate including a layer of photoresist to be patterned with the pattern.

18. The apparatus of claim 17, wherein the first set of poles is to pattern small pitch areas on the substrate, and the second set of poles is to pattern large pitch areas on the substrate.

19. The apparatus of claim 17, wherein the mask is an embedded phase shift mask (EPSM).

20. The apparatus of claim 17, wherein the first set of poles have an arc-shape, and wherein the second set of poles have an elliptical shape.

21. The apparatus of claim 17, wherein the first and second sets of poles are adjustable to change characteristics of the hybrid light source.

22. The apparatus of claim 17, wherein the second set of poles comprises four poles.

23. The apparatus of claim 22, wherein first set of poles comprises two poles.

24. The apparatus of claim 22, wherein the first set of poles comprises four poles.

25. The apparatus of claim 17, wherein the first set of poles are located approximately at an edge of the hybrid light source.

26. A method comprising:
generating a light using a light source including a first set of poles and a second set of poles closer to a center of the light source than the first set of poles; and
projecting the light through projection optics onto a layer of photoresist to form a pattern on the layer of photoresist.

27. The method of claim 26, further comprising:
locating the first set of poles including four arc-shaped poles at an edge of the light source; and
locating the second set of poles including four elliptical poles between the first set of poles and the center of the light source.

28. The method of claim 26, further comprising:
locating the first set of poles including two arc-shaped poles at an edge of the light source; and
locating the second set of poles including four elliptical poles between the first set of poles and the center of the light source.

29. The method of claim 26, wherein projecting comprises:
projecting the light through a first lens, a mask, and a second lens, and onto the photoresist.
